(19) United States
(12) Patent Application Publication
(10) Pub. No.: US 2026/0030071 A1
(43) Pub. Date: Jan. 29, 2026

(54) METHOD FOR AHEAD-OF-TIME TRANSLATION OF APPLICATION CONTAINER IMAGES INTO NATIVE CODE FOR DIVERSE EMBEDDED DEVICES

(71) Applicant: Atym, Inc., San Francisco, CA (US)

(72) Inventors: Stephen Roland BERARD, Rasteau (FR); Jason Alan SHEPHERD, Austin, TX (US)

(21) Appl. No.: 19/281,167

(22) Filed: Jul. 25, 2025

Related U.S. Application Data
(60) Provisional application No. 63/675,654, filed on Jul. 25, 2024.

(51) Int. Cl. G06F 9/50; G06F 8/61; G06F 9/30

(52) U.S. Cl. CPC G06F 9/505; G06F 8/63; G06F 9/3001; G06F 9/30036

(57) ABSTRACT

A method includes: based on a request to deploy an initial container image onto a set of target devices, accessing the initial container image including an initial application binary representing an initial set of operations and characterized by an initial processor instruction set architecture; accessing a first set of attributes of a first device in the set of target devices, the first set of attributes characterized by a first processor instruction set architecture different from the initial processor instruction set architecture; based on the first set of attributes, identifying a first set of operations corresponding to the initial set of operations and characterized by the first instruction set architecture; translating the initial application binary into a first optimized application binary representing the first set of operations; generating a first container image comprising the first application binary; and deploying the first container image onto the first device for execution.

### CROSS-REFERENCE TO RELATED APPLICATIONS

This application claims the benefit of U.S. Provisional Application No. 63/675,654, filed on 25 Jul. 2024, which is incorporated in its entirety by this reference.

### TECHNICAL FIELD

This invention relates generally to the field of software application containerization and, more specifically, to a new and useful method for ahead-of-time translation of application container images into native code for diverse embedded devices within the field of software application containerization.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method; and

FIG. 4 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

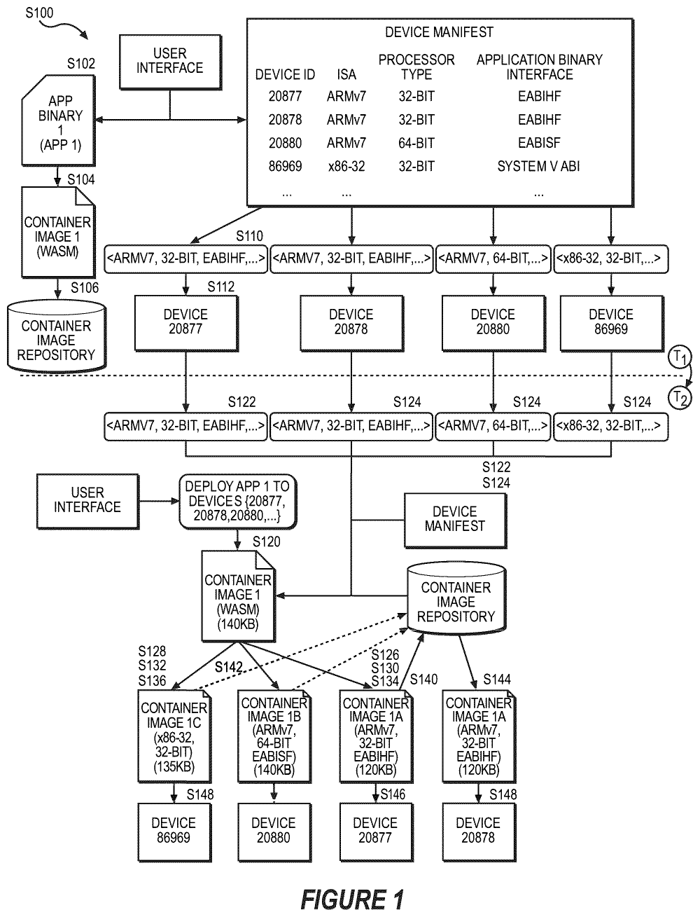

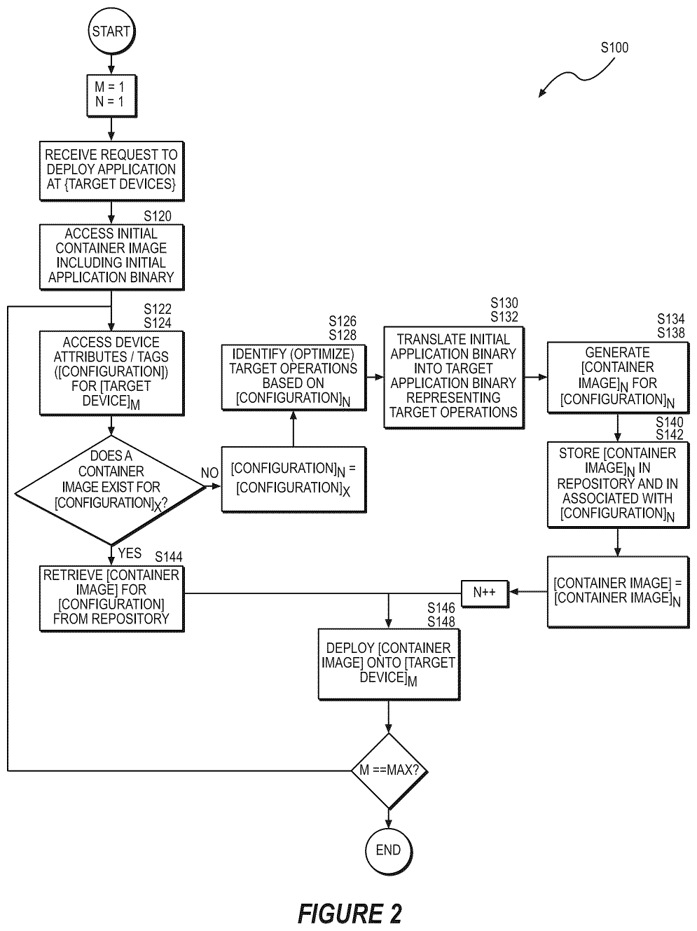

As shown in FIGS. 1 and 2, a method S100 includes: based on a request to deploy an initial container image onto a set of target devices, accessing the initial container image including an initial application binary in Block S120; and accessing a first set of attributes of a first device in the set of target devices in Block S122. The initial application binary: represents an initial set of operations—of an application-including a first subset of operations characterized by a first quantity of operations; and is characterized by an initial instruction set architecture. The first set of attributes is characterized by: a first instruction set architecture different from the initial instruction set architecture; and a first processor type.

The method S100 further includes, based on the first set of attributes, identifying a first set of operations corresponding to the initial set of operations and characterized by the first instruction set architecture in Block S126. The first set of operations includes a second subset of operations: corresponding to the first subset of operations; and characterized by a second quantity of operations falling below the first quantity of operations.

The method S100 also includes: translating the initial application binary into a first application binary representing the first set of operations in Block S130; generating a first container image including the first application binary in Block S134; storing the first container image in a container image repository and in association with a first configuration in Block S140; and deploying the first container image onto the first device for execution in Block S146. The first configuration is characterized by: the first instruction set architecture; and the first processor type.

### 1.1 Variation: Ahead-of-Time Compilation for Target Embedded Device

As shown in FIGS. 1 and 2, one variation of the method S100 includes, during a first time period: accessing an initial application binary in Block S102; generating an initial container image including the application binary in Block S104; and storing the initial container image in a container image repository in Block S106. The initial application binary: represents an initial set of operations—of an application-including a first subset of operations characterized by a first quantity of operations; and is characterized by an initial instruction set architecture.

This variation of the method S100 also includes, during the first time period: generating a first set of tags representing a first set of attributes of a first embedded device in Block S110; and installing the first set of tags on the first embedded device in Block S112. The first set of tags specify: a first instruction set architecture different from the initial instruction set architecture; and a first processor type.

This variation of the method S100 further includes, during a second time period succeeding the first time period: in response to reception of a request to deploy the initial container image onto a set of target embedded devices including the first embedded device, accessing the initial container image in the container image repository in Block S120; receiving an indication of the first set of tags from the first embedded device in Block S122; based on the first set of tags, identifying a first set of operations corresponding to the initial set of operations and characterized by the first instruction set architecture in Block S126; translating the initial application binary into a first application binary representing the first set of operations in Block S130; generating a first container image including the first application binary in Block S134; storing the first container image in the container image repository and in association with a first configuration in Block S140; and deploying the first container image onto the first embedded device for execution in Block S146. The first set of operations includes a second subset of operations: corresponding to the first subset of operations; and characterized by a second quantity of operations falling below the first quantity of operations. The first configuration is characterized by: the first instruction set architecture; and the first processor type.

### 1.2 Variation: Ahead-of-Time Compilation for Heterogenous Devices

As shown in FIGS. 1 and 2, one variation of the method S100 includes: based on a request to deploy an initial container image onto a set of target devices, accessing the initial container image including an initial application binary in Block S120; and accessing a first set of attributes of a first device in the set of target devices in Block S122. The initial application: represents an initial set of operations of an application; and is characterized by an initial instruction set architecture. The first set of attributes is characterized by: a first instruction set architecture different from the initial instruction set architecture; and a first processor type.

This variation of the method S100 also includes accessing a second set of attributes of a second device in the set of target devices in Block S124. The second set of attributes is characterized by: the first instruction set architecture; and a second processor type different from the first processor type.

This variation of the method S100 further includes: based on the first set of attributes, identifying a first set of operations corresponding to the initial set of operations and characterized by the first instruction set architecture in Block S126; and, based on the second set of attributes, identifying a second set of operations in Block S128. The second set of operations: is different from the first set of operations; corresponds to the initial set of operations; and is characterized by the first instruction set architecture.

This variation of the method S100 also includes: translating the initial application binary into a first application binary representing the first set of operations in Block S130; translating the initial application binary into a second application binary representing the second set of operations in Block S132; generating a first container image including the first application binary in Block S134; generating a second container image including the second application binary in Block S136; storing the first container image in a container image repository and in association with a first configuration in Block S140; storing the second container image in the container image repository and in association with a second configuration in Block S142; deploying the first container image onto the first device for execution in Block S146; and deploying the second container image onto the second device for execution in Block S148. The first configuration is characterized by: the first instruction set architecture; and the first processor type. The second configuration is characterized by: the first instruction set architecture; and the second processor type.

### 2. Applications

Generally, a computer system (hereinafter “the system”) including a remote computer system (e.g., a remote server) can execute Blocks of the method S100: to receive a target application compiled according to an initial instruction set architecture (e.g., “WebAssembly”); to package the target application into an initial, immutable application container image (hereinafter “container image”) including components required for executing the target application in a container runtime environment at an embedded device (e.g., an IoT device, a camera, a sensor, a PC, a server, a smartphone); to store this initial container image in a container image repository; and to register a set of diverse embedded devices characterized by a set of different instruction set architectures (e.g., “×86-32,” “ARMv7,” “MIPS64,” “SPARC-V9”).

Then, in response to a request to deploy the target application onto a first embedded device, the system can execute Blocks of the method S100: to retrieve the initial container image associated with the target application from the container image repository; to identify a first set of attributes of the first embedded device, such as a first instruction set architecture (e.g., “ARMv7”) of the first embedded device, a first processor type (e.g., 32-bit) of the first embedded device, and a first application binary interface format (e.g., a hardware floating-point application binary interface format) of the first embedded device; to convert the initial container image-characterized by the initial instruction set architecture-into a first container image characterized by the first instruction set architecture and representing operations (or instructions) based on capabilities of the first embedded device according to the first set of attributes; to store the first container image in the container image repository and in association with a first configuration corresponding to the first set of attributes; and to deploy the first container image onto the first embedded device for execution.

Therefore, rather than deploying the initial container image onto the first embedded device (which must then interpret and/or translate instructions from the initial instruction set architecture to the first instruction set architecture during execution of the target application), the system can execute Blocks of the method S100: to translate—at the remote computer system and prior to deployment at the first embedded device—the initial container image representing the target application into native machine code specific to the first instruction set architecture of the first embedded device; and deploy this native machine code for execution at the first embedded device, thereby enabling faster execution (e.g., reduced completion time) of the target application while achieving other potential benefits, such as reducing resource (e.g., memory, processor) overhead at the first embedded device.

Additionally, in response to the request indicating deployment of the target application onto additional embedded devices, the system can repeat Blocks of the method S100 for each of these embedded devices: to identify a set of attributes of the embedded device; to access (or generate) a target container image associated with a configuration corresponding to the set of attributes of the embedded device; and to deploy the target container image onto the embedded device for execution.

For example, the system can execute Blocks of the method S100: to identify a second set of attributes of a second embedded device indicated in the request; and, in response to detecting correspondence between the second set of attributes and the first configuration (e.g., the first instruction set architecture, the first processor type, the first application binary interface format), to retrieve the first container image from the container image repository; and to deploy the first container image onto the second embedded device for execution.

However, in response to detecting a difference between the second set of attributes—such as including a second instruction set architecture (e.g., “×86-32”) different from the first instruction set architecture, a second processor type (e.g., ARM 64-bit) different from the first processor type, and/or a second application binary interface format (e.g., a software floating-point application binary interface format) different from the first application binary interface format—and the first configuration, the system can execute Blocks of the method S100: to convert the initial container image into a second container image characterized by the second instruction set architecture and representing operations (or instructions) based on capabilities of the second embedded device according to the second set of attributes; to store the second container image in the container image repository and in association with a second configuration corresponding to the second set of attributes; and to deploy the second container image onto the second embedded device for execution.

Therefore, the system can execute Blocks of the method S100: to receive an initial container image (or initial application binary) that is instruction set independent from a user (e.g., an application developer, a system administrator); to automatically generate a set of container images characterized by—and optimized for—various different hardware configurations (e.g., instruction set architectures, processor types, application binary interface formats) based on the initial container image on behalf of the user and absent user intervention; and deploy a container image to a corresponding embedded device according to a hardware configuration of the embedded device in order to reduce human error and/or effort during deployment of a target application to a fleet of embedded devices (e.g., thousands of embedded devices) characterized by these different hardware configurations.

### 2.1 Operation Tuning

In one example, in response to the request to deploy the target application onto the first embedded device, the system executes Blocks of the method S100: to identify operations, in the initial container image, corresponding to a series of load and multiply instructions; and to identify a vector acceleration capability associated with the first embedded device.

In this example, rather than including the series of load and multiply instructions in the first container image for the first embedded device, the system can execute Blocks of the method S100: to replace the series of load and multiply instructions with a single vector operation yielding an equivalent result as the series of load and multiply instructions; and generate the first container image including this vector operation.

Therefore, the system can execute Blocks of the method S100 to tune operations of the first container image according to the vector acceleration capability specific to the first embedded device—absent intervention by the user—in order to achieve faster execution time of the target application at the first embedded device.

### 2.2 Variation: Other Device Types

As described herein, the system executes Blocks of the method S100: to convert an initial container image—characterized by an initial instruction set architecture—into a target container image characterized by a target instruction set architecture based on a target set of attributes of a target embedded device; and to deploy the target container image onto the target embedded device for execution.

However, the system can similarly execute Blocks of the method S100: to convert the initial container image characterized by the initial instruction set architecture into a target container image characterized by a target instruction set architecture—of a target device of another type (e.g., a general purpose computer, a laptop computer, a tablet, a smartphone)—based on a target set of attributes of the target device; and to deploy the target container image onto the target device for execution.

### 3. Terminology

Generally, an “application binary” is referred to herein as compiled, executable instructions (or “machine code”) representing an application and specific to an instruction set architecture, such as a physical instruction set architecture (e.g., “ARMv7,” “×86-32”) or a bytecode instruction set architecture (e.g., “WebAssembly,” “JAVA Virtual Machine Instruction Set”).

Generally, a “container image” is referred to herein as an immutable, executable file including an application binary and any additional dependencies for executing the application binary.

### 4. System

Generally, the system can include or interface with: a user device (e.g., a desktop computer, a laptop computer, a tablet, a smartphone) accessed by a user such as an application developer or system administrator; a remote computer system (e.g., a remote server); and a set of devices (e.g., embedded devices, edge devices, IoT devices, cameras, sensors, servers, smartphones). Each device in the set of devices can be characterized by an instruction set architecture (e.g., “×86-32,” “ARMv7,” “MIPS64,” “SPARC-V9”) in a set of instruction set architectures.

In one implementation, the remote computer system receives a target application from the user device (e.g., via a user interface).

More specifically, the remote computer system can receive an initial application binary characterized by an initial instruction set architecture (e.g., “WebAssembly”). The initial application binary can include an initial set of instructions-representing an initial set of operations of the target application-compiled according to the initial instruction set architecture.

In this implementation, the remote computer system: generates an initial container image (or a “containerized application”) representing the target application; and stores the initial container image in a container image repository. For example, the remote computer system can generate the initial container image including: the initial application binary; a set of dependencies (e.g., libraries, other binaries); a set of configuration files; a set of metadata; etc.

In another implementation, in response to a request to deploy the initial container image onto a set of target devices in the set of devices, the remote computer system: identifies a first instruction set architecture (e.g., “ARMv7”) characterizing a first device in the set of target devices; accesses the initial container image from the container image repository; and converts (or translates) the initial container image-characterized by the initial instruction set architecture-into a first container image characterized by the first instruction set architecture.

More specifically, the remote computer system can: identify the initial set of operations represented in the initial container image; identify a first set of operations corresponding to the initial set of operations and characterized by the first instruction set architecture; generate a first container image representing the first set of operations; and deploy the first container image onto the first device characterized by the first instruction set architecture.

Therefore, rather than deploying the initial container image-including the initial application binary compiled according to the initial instruction set architecture (e.g., “WebAssembly”)—onto the first device (which must interpret and/or translate the initial application binary into the first instruction set architecture prior to execution), the remote computer system can convert the initial container image into the first container image characterized by the first instruction set architecture for native execution at the first device in order: to reduce computation and/or memory overhead at the first device; and/or to increase execution speed of the target application at the first device.

The remote computing system can repeat the foregoing methods and techniques for each device in the set of target devices.

For example, the system can: identify a second instruction set architecture (e.g., “×86-32”) characterizing a second device in the set of target devices; identify a second set of operations corresponding to the initial set of operations and characterized by the second instruction set architecture; generate a second container image representing the second set of operations; and deploy the second container image onto the second device characterized by the second instruction set architecture.

### 4.1 Devices

In one implementation, a device (e.g., an embedded device, a resource-constrained device) includes a set of resources, such as: a processor (e.g., a central processing unit, a microcontroller); a graphics processing unit; memory; storage; an internal communication bus; a network interface; etc.

### 4.2 Container Runtime Module

Generally, the device can include a container runtime module for executing a container image. More specifically, the container runtime can include a container runtime environment and a hardware abstraction layer.

In one implementation, the container runtime module includes an operating system (e.g., a real-time operating system, a LINUX operating system, an ANDROID operating system) and/or a set of container functions (e.g., data extraction functions, data processing functions, machine learning functions) for executing a container image.

In this implementation, the container runtime module maps the set of container functions to the set of resources of the embedded device via the hardware abstraction layer.

### 5. Device Registration

Generally, as shown in FIG. 1, during a first time period (e.g., a “registration period”), the remote computer system can identify a set of devices associated with an entity (e.g., a user, an organization).

In one implementation, the remote computer system identifies a first device in the set of devices. More specifically, the remote computer system can: access (or detect) a first set of attributes (e.g., hardware attributes) characterizing the first device; and store the first set of attributes in a first profile associated with the first device (and/or a first device identifier assigned to the first device).

For example, the remote computer system can identify the first set of attributes including: an instruction set architecture of the first device; a processor type (e.g., CPU or MCU, word size, a quantity of cores) of the first device; an application binary interface of the first device; an application binary interface (e.g., an embedded application binary interface) format (e.g., hardware floating-point (or “hard-float”) application binary interface for ARM targets, double-precision hardware floating-point application binary interface, single-precision hardware floating-point application binary interface, software floating-point (or “soft-float”) application binary interface) of the first device; a memory capacity (e.g., kilobytes of memory capacity) of the first device; a memory type (e.g., EEPROM, flash memory, SRAM, DRAM, DDRSRAM, GPIO external memory) of the first device; a storage capacity (e.g., megabytes of storage, gigabytes of storage) of the first device; a storage type (e.g., flash storage, hard disk storage) of the first devices; a peripheral bus type (e.g., I2C, MODBUS, CAN bus); a sensor type (e.g., a pressure sensor, an accelerometer, a temperature sensor) associated with the first device; a hardware accelerator type of the first device; a network interface (e.g., Ethernet, WiFi, LoraWAN, cellular) of the first device. and/or other peripherals of the first device.

Therefore, the remote computer system can fully characterize components and capabilities of the first device in order to translate an initial container image into a target container image characterized by a target instruction set architecture of the first device and/or to tune operations—represented by the target container image—specific to these components and capabilities of the first device.

The remote computer system can repeat the foregoing methods and techniques for each device in the set of devices: to access a set of attributes characterizing the device; and to store the set of attributes in a profile associated with the device.

Therefore, the remote computer system can manage deployment of a single container image to a fleet of devices (e.g., thousands of embedded devices) characterized by different instruction set architectures and including diverse sets of resources.

### 5.1 Tags

In one implementation, the remote computer system: generates a first set of tags representing the first set of attributes of the first device in Block S110; and installs the first set of tags on the first device in Block S112.

For example, the remote computer system can select a first subset of attributes—in the first set of attributes—including: a first instruction set architecture; a first processor type; and a first application binary interface format.

In this example, the remote computer system can: generate the first set of tags representing the first subset of attributes; and install the first set of tags on the first device. More specifically, the remote computer system can compile the first set of tags in firmware of the first device.

The remote computer system repeats the foregoing methods and techniques for each device in the set of devices: to generate a set of tags representing a set of attributes of the device; and to install the set of tags on the device.

For example, the remote computer system can: select a second subset of attributes—in a second set of attributes of a second device in the set of devices—including: the first instruction set architecture (or a second instruction set architecture different from the first instruction set architecture); a second processor type different from the first processor type; and a second application binary interface format different from the first application binary interface format.

In this example, the remote computer system can execute the foregoing methods and techniques: to generate a second set of tags representing the second subset of attributes; and to install the second set of tags on the second device.

Therefore, the remote computer system can identify a configuration (e.g., a hardware configuration) of a device according to a set of tags installed on the device.

### 6. Container Images

The method S100 includes: accessing the application binary from an interface in Block S102; generating the initial container image including the application binary in Block S104; and storing the initial container image in the container image repository in Block S106.

Generally, in Blocks S102, S104, and S106, the remote computer system can: receive an application binary representing a target application for execution at a set of target devices; generate a container image including the application binary; and store the container image in a container image repository.

In one implementation, the user device: accesses a target application (e.g., a first application) including an initial set of operations; and compiles the target application into an initial application binary according to an initial instruction set architecture (e.g., “WebAssembly”). The initial application binary includes an initial set of instructions (e.g., bytecode, machine code) representing the initial set of operations and characterized by the initial instruction set architecture.

In this implementation, the user device transmits (e.g., uploads) the initial application binary to the remote computer system.

In another implementation, in Block S102, the remote computer system receives the initial application binary from the user device (e.g., via a user interface executing on the user device, via an application programming interface).

In response to receiving the application binary, the remote computer system generates an initial container image including the initial application binary in Block S104. For example, the container image can include: the initial application binary; a set of dependencies (e.g., libraries, other binaries) for executing the initial application binary; a set of configuration files; and/or a set of metadata; etc.

In this implementation, the remote computer system stores the initial container image—characterized by the initial instruction set architecture—in the container image repository in Block S106.

For example, the remote computer system can store the initial container image characterized by an initial container identifier (e.g., a hash of the initial container image).

Additionally or alternatively, the remote computer system can store the initial container image associated with an application identifier of the target application represented by the initial application binary in the initial container image.

Therefore, the system can abstract architecture and orchestration of diverse devices in order to simplify application development for a user (e.g., an application developer) to develop, test, and/or deploy an application on these diverse devices.

### 7. Ahead-of-Time Application Binary Translation

Block S120 of the method S100 recites, based on a request to deploy an initial container image onto a set of target devices, accessing the initial container image including an initial application binary. The initial application binary: represents an initial set of operations of an application; and is characterized by an initial instruction set architecture.

Block S122 of the method S100 recites accessing a first set of attributes of a first device in the set of target devices. The first set of attributes is characterized by: a first instruction set architecture different from the initial instruction set architecture; and a first processor type.

The method S100 includes: based on the first set of attributes, identifying a first set of operations corresponding to the initial set of operations and characterized by the first instruction set architecture in Block S126; translating the initial application binary into a first application binary representing the first set of operations in Block S130; generating a first container image including the first application binary in Block S136; storing the first container image in a container image repository in Block S140; and deploying the first container image onto the first device for execution in Block S146. The first container image is stored in association with a first configuration characterized by: the first instruction set architecture; and the first processor type.

Generally—as shown in FIGS. 1 and 2, and in Blocks S120, S122, S126, S130, S136, S140, and S146—during a second time period (e.g., a “deployment period”) succeeding the first time period, the remote computer system can: receive a request to deploy the target application onto the set (or a subset) of devices; retrieve an initial container image-representing the target application and characterized by an initial instruction set architecture—from the container image repository; based on the initial container image, generate a set of container images characterized by a set of instruction set architectures of the set of devices; and deploy the set of container images onto the set of devices.

Therefore, rather than interpreting and/or translating the initial application binary—included in the initial container image and characterized by the initial instruction set architecture—during runtime (e.g., just-in-time compilation) at a device identified in the request, the remote computer system can: translate the initial application binary representing the target application into native machine code specific to an instruction set architecture of the device; and deploy the native machine code for execution on the device, thereby enabling faster execution (e.g., reduced completion time) of the target application while reducing resource (e.g., memory, processor) overhead for the device.

### 7.1 Request

In one implementation, the remote computer system receives a request (e.g., via the user interface) to deploy a first application onto the set of devices.

More specifically, the remote computer system can receive a request to deploy an initial container image—representing the first application—onto a subset of target devices in the set of devices.

For example, the remote computer system can receive a request to deploy the initial container image onto a set of target devices (e.g., a set of target embedded devices) in a fleet of devices (e.g., a fleet of embedded devices).

In this example, the remote computer system can receive the request indicating: a first application identifier associated with the first application; and a set of device identifiers associated with the set of target devices.

Additionally or alternatively, the remote computer system can receive the request indicating an initial container identifier of the initial container image.

In response to reception of the request indicating the initial application (and/or the initial container image), the remote computer system accesses the initial container image—associated with the first application—from the container image repository in Block S120. The initial container image includes an initial application binary representing the first application and characterized by an initial instruction set architecture (e.g., “WebAssembly”).

### 7.2 First Embedded Device

In one implementation, the remote computer system receives the request indicating a subset of target devices including a first device (e.g., a first embedded device) in the set of devices.

In response to receiving the request indicating the first device, the remote computer system accesses a first set of attributes of the first device in Block S122.

In one example, the remote computer system: receives the request specifying a first device identifier assigned to the first device; accesses a first profile associated with the first device based on the first device identifier; and identifies a first set of attributes—of the first device—stored in the first profile.

In this example, the remote computer system identifies the first set of attributes including (or characterized by): a first instruction set architecture of the first device and different from the initial instruction set architecture; a first processor type; and/or a first application binary interface format (e.g., a first embedded application binary interface format).

In another example, the remote computer system receives an indication of a first set of tags—representing the first set of attributes and specifying a first instruction set architecture of the first device—from the first device.

In another implementation, the remote computer system executes the foregoing methods and techniques to access the initial container image, including an initial application binary representing an initial set of operations.

In this implementation, the remote computer system: identifies an initial set of operations of the first application represented in the initial container image; identifies a first set of operations—characterized by the first instruction set architecture—corresponding to the initial set of operations based on the set of attributes and/or the first set of tags in Block S126; translates the initial application binary into a first application binary representing the first set of operations in Block S130; and generates a first container image including the first application binary in Block S136.

In one example, the remote computer system: extracts an initial application binary representing the first application from the initial container image; and identifies the initial set of operations based on the initial application binary. For each operation in the initial set of operations characterized by the initial instruction set architecture, the remote computer system identifies a corresponding operation—in the first set of operations—characterized by the first instruction set architecture.

More specifically, the remote computer system can extract an initial set of instructions—characterized by the initial instruction set architecture—from the initial application binary. Then, for a first instruction in the initial set of instructions, the remote computer system can identify a second instruction (or a subset of instructions)—in a first set of instructions characterized by the first instruction set architecture—corresponding to the first instruction.

The remote computer system can repeat the foregoing methods and techniques for each instruction in the initial set of instructions to identify a target instruction—in the first set of instructions—characterized by the first instruction set architecture and corresponding to the instruction in the initial set of instructions.

In this example, the remote computer system: translates the initial application binary into the first application binary representing the first set of operations and/or including the first set of instructions; and generates the first container image including the first application binary characterized by the first instruction set architecture.

Additionally, the remote computer system can generate the first container image including: a set of dependencies (e.g., libraries, other binaries) for executing the first application binary; a set of configuration files; and/or a set of metadata; etc.

In one implementation, in Block S140, the remote computer system: associates the first container image with a first configuration and/or the first device; and stores the first container image in the container image repository. The first configuration is characterized by a subset of attributes in the first set of attributes, such as the first instruction set architecture, the first processor type, and/or the first application binary interface format.

For example, the system can: store the first container image characterized by a first container identifier: mapped to the initial container identifier as a first index element in a set of index elements for the initial container identifier; and associated with the first configuration.

In another implementation, in Block S146, the remote computer system deploys (e.g., installs) the first container image to the first device for execution, such as within a container runtime environment-installed on the first device—via a hardware abstraction layer.

Therefore, the remote computer system can: translate the initial set of instructions—characterized by the initial instruction set architecture—into the first set of instructions characterized by the first instruction set architecture; generate the first container image including the first set of instructions; and deploy the first container image onto the first device for native execution of the first set of instructions.

### 7.3 Second Embedded Device

In one implementation, in Block S124, the remote computer system executes the foregoing methods and techniques to access a second set of attributes—and/or a second set of tags—of a second device in the subset of target devices.

In one example, the remote computer system accesses the second set of attributes characterized by; the first instruction set architecture; a second processor type (e.g., a second processor type different from the first processor type); and/or a second application binary interface format (e.g., a second embedded application binary interface format difference from the first embedded application binary interface format).

In another example, the remote computer system accesses the second set of attributes characterized by: a second instruction set architecture different from the initial instruction set architecture and the first instruction set architecture; the second processor type; and/or the second application binary interface format.

In another implementation, the remote computer system scans the container image repository for a target container image—corresponding to the initial container image—associated with a target configuration that corresponds to the second set of attributes (and/or the second set of tags).

In response to detection of correspondence between the second set of attributes (and/or the second set of tags) and the first configuration characterized by the first instruction set architecture, the remote computer system retrieves (or accesses) the first container image from the container image repository in Block S144; and deploys the first container image onto the second device for execution in Block S148.

For example, the remote computer system can retrieve the first container image from the container image by indexing into the container image repository according to the first container identifier mapped to the initial container identifier.

Alternatively, in response to detection of a difference between the second set of attributes (and/or the second set of tags) and the first configuration—and in response to absence of a target container image, in the container image repository, associated with a target configuration corresponding to the second set of attributes and/or the second set of tags—the remote computer system executes the foregoing methods and techniques: to identify a second set of operations corresponding to the initial set of operations based on the second set of attributes in Block S128; to translate the initial application binary into a second application binary representing the second set of operations in Block S132; and to generate a second container image including the second application binary in Block S136.

The remote computer system then executes the foregoing methods and techniques: to associate the second container image with a second configuration—different from the first configuration—and/or the second device; to store the second container image in the container image repository and in association with the second configuration in Block S142; and to deploy the second container image onto the second device for execution in Block S148.

For example, the remote computer system can store the second container image in association with the second configuration characterized by a subset of attributes in the second set of attributes, such as the second instruction set architecture, the second processor type, and/or the second application binary interface format.

### 7.4 Additional Embedded Devices

The remote computer system repeats the foregoing methods and techniques for each device in the subset of target devices: to access a set of attributes (and/or a set of tags) of the device; and to scan the container image repository for a target container image—corresponding to the initial container image—associated with a target configuration that corresponds to the set of attributes (and/or the set of tags).

In response to detection of correspondence between the set of attributes and the target configuration, the remote computer system executes the foregoing methods and techniques: to retrieve the target container image from the container image repository; and to deploy the target container image onto the device for execution.

Alternatively, in response to absence of the target container image associated with the target configuration corresponding to the set of attributes—the remote computer system executes the foregoing methods and techniques: to identify a target set of operations corresponding to the initial set of operations based on the set of attributes; to translate the initial application binary into a target application binary representing the target set of operations based on the set of attributes; to generate a new container image including the target application binary; to store the new container image in the container image repository and in association with a new configuration according to the set of attributes; and to deploy the new container image onto the device for execution.

### 8. Operation Tuning

Generally, the remote computer system can: identify a target set of attributes associated with a target device in the subset of target devices specified in the request; identify the initial set of operations represented in the initial container image; tune a target set of operations (and/or a target set of instructions)—corresponding to the initial set of operations—based on the target set of attributes according to a set of tuning metrics; and to generate a target container image representing the target set of operations.

For example, the remote computer system can tune the target set of operations (and/or the target set of instructions) based on the target set of attributes including: processor utilization (e.g., minimize processor cycles); memory utilization (e.g., minimize memory overhead); execution speed (e.g., minimize completion time); execution determinism (e.g., maximize consistent execution); and/or file size (e.g., minimize application binary size), etc.

Therefore, based on the first set of attributes of the target device, the remote computer system can generate the target container image representing the target set of operations—specific to components and capabilities of the target device—in order: to achieve faster execution times; to achieve more consistent execution determinism; and/or to minimize resource (e.g., processor, memory, storage) consumption, etc.

### 8.1 Operation Reduction

In one implementation, the remote computer system executes the foregoing methods and techniques: to access the first set of attributes of the first device in the subset of target devices; and to identify the initial set of operations of the first application represented in the initial container image.

For example, the remote computer system can access the first set of attributes characterized by the first instruction set architecture defining a set of vector instructions.

In this example, the remote computer system can identify the initial set of operations including a first subset of operations: representing a set of scalar load instructions and scalar multiply instructions; and characterized by a first quantity of operations.

In response to detection of vector acceleration capability of the first device based on the set of vector instructions defined in the first instruction set architecture, the remote computer system can identify a second subset of operations (e.g., vector operations): characterized by the first instruction set architecture; corresponding to the first subset of operations representing the set of scalar load instructions and scalar multiplication instructions; and characterized by a second quantity of operations falling below the first quantity of operations.

More specifically, the remote computer system can: identify a subset vector instruction(s) corresponding to (e.g., equivalent to) the set of scalar load instructions and scalar multiply instructions; and translate the initial application binary into the first application binary—representing the first set of operations including the second subset of operations—by replacing scalar load instructions and scalar multiply instructions with vector instructions in the set of vector instructions.

The remote computer system then executes the foregoing methods and techniques: to generate the first container image including the first application binary; to store the first container image in the container image repository; and to deploy the first container image onto the first device for execution.

Therefore, the remote computer system can tune the first set of operations according to the vector acceleration capability specific to the first device (and more generally to the first configuration)—absent intervention by the user—in order to achieve faster execution time of the first application.

### 8.1.1 Absence of Vector Acceleration Capability

In one variation, the remote computer system executes the foregoing methods and techniques: to access the second set of attributes of the second device in the subset of target devices; and to identify the initial set of operations of the first application represented in the initial container image.

For example, the remote computer system can: access the second set of attributes characterized by the second instruction set architecture absent a set of vector instructions.

In this example, the remote computer system can identify the initial set of operations including the first subset of operations: representing the set of scalar load instructions and scalar multiply instructions; and characterized by the first quantity of operations.

In response to absence of vector acceleration capability of the second device based on absence of vector instructions defined in the second instruction set architecture, the remote computer system can identify a third subset of operations: characterized by the second instruction set architectures; corresponding to the first subset of operations representing the set of scalar load instructions and scalar multiplication instructions; and characterized by a third quantity of operations corresponding to the first quantity of operations.

The remote computer system then executes the foregoing methods and techniques: to translate the initial application binary into the second application binary representing the second set of operations including the third subset of operations; to generate the second container image including the second application binary; to store the second container image in the container image repository; and to deploy the second container image onto the second device for execution.

### 8.2 Tuning Permutations

In another variation, the remote computer system executes the foregoing methods and techniques: to identify the initial set of operations, including the first subset of operations, represented in the initial container image; to identify the first set of attributes of the first device; and to identify the second subset of operations—in a group of subsets of operations—corresponding to the first subset of operations based on the first set of attributes as a first tuning permutation in a set of tuning permutations.

In this variation, the remote computer system repeats the foregoing methods to identify each (different) subset of operations—in the group of subsets of operations—corresponding to the first subset of operations based on the first set of attributes as a tuning permutation in the set of tuning permutations.

For example, the remote computer system can identify a third subset of operations, in the group of subsets of operations, corresponding to the first subset of operations—and different from the second subset of operations—based on the first set of attributes as a second tuning permutation in the set of tuning permutations.

The remote computer system then selects a target subset of operations in the group of subsets of operations (e.g., a target tuning permutation in the set of tuning permutations) based on the set of tuning metrics; and generates the first container image representing the first set of operations including the target subset of operations.

For example, the remote computer system can: calculate a first quantity of bits representing the second subset of operations (or a first candidate application binary representing the second subset of operations); and calculate a first score, in a set of scores for the group of subsets of operations, for the second subset of operations based on the first quantity of bits.

The remote computer system repeats the foregoing methods and techniques for each subset of operations in the group of subsets of operations: to calculate a quantity of bits representing the subset of operations (or a candidate application binary representing the subset of operations); and to calculate a score, in the set of scores, for the subset of operations based on the quantity of bits.

In this example, the remote computer system can select the second subset of operations for the first set of operations—in response to detection of the first score characterized by a greatest score in the set of scores (e.g., the first score exceeding all other scores in the set of scores)—based on the set of tuning metrics including file size minimization.

In response to selecting the second subset of operations, the remote computer system executes the foregoing methods and techniques: to generate the first container image representing the first set of operations including the second subset of operations; to store the first container image in the container image repository; and to deploy the first container image onto the first device for execution.

Therefore, the remote computer system can: automatically generate a set of tuning permutations based on the first set of attributes of the first device; rank the set of tuning permutations according to the set of tuning metrics defined by a user (e.g., an application developer, a deployment engineer); and deploy a container image-representing the target tuning permutation exhibiting the highest rank—to the first device.

### 9. Variation: Target Tags

In one variation, the remote computer system executes the foregoing methods and techniques to receive a request—to deploy an initial container image onto a subset of target devices—specifying a target set of tags for the subset of target devices.

For example, the remote computer system can receive the request specifying the target set of tags including: a target instruction set architecture; a target processor type; and/or a target application binary interface format.

In this variation, the remote computer system validates the target set of tags to verify that an application binary—generated according to the target set of tags—successfully compiles and/or is executable.

In response to (successful) validation of the target set of tags, the remote computer system executes the foregoing methods and techniques to access the initial container image representing the initial set of operations; and to access the first set of tags representing the first set of attributes of the first device.

In response to detection of correspondence between the first set of tags and the target set of tags, the remote computer system executes the foregoing methods and techniques: to identify the first set of operations corresponding to the initial set of operations based on the first set of tags; to generate the first container image representing the first set of operations; to store the first container image in the container image repository; and to deploy the first container image onto the first device for execution.

However, in response to identifying the target set of tags as invalid (e.g., identifying that an application binary-generated according to the target set of tags-fails to compile), the remote computer system can: generate a notification indicating that the target set of tags is invalid; and serve the notification to the user.

### 10. Execution Characteristics and Feedback

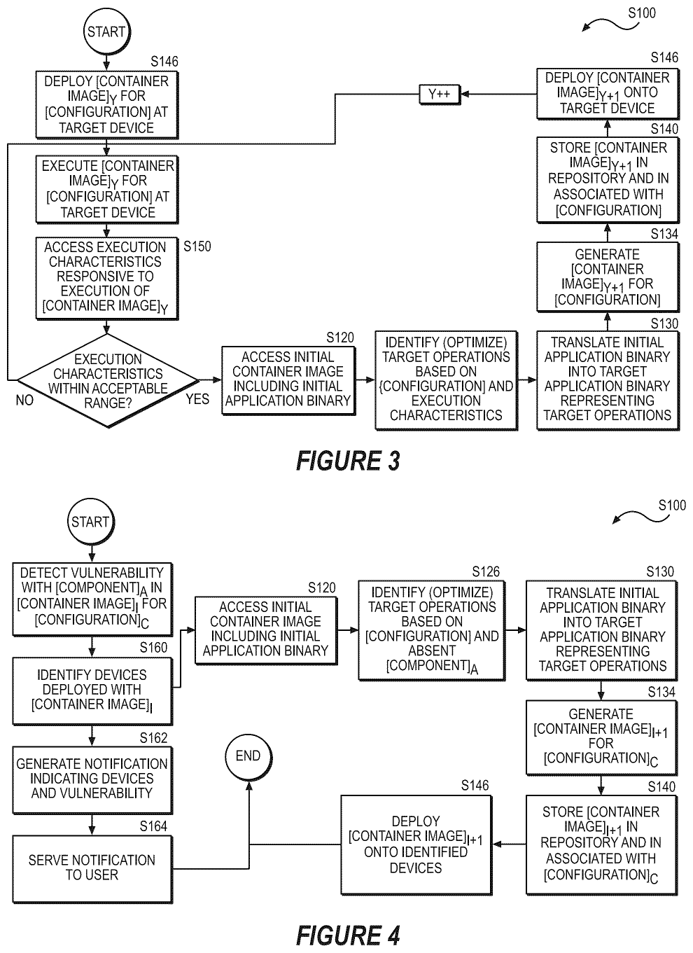

In one implementation, as shown in FIG. 3, in response to installation of the first container image at the first device, the first device executes the first container image within a container runtime environment-installed on the first device—via a hardware abstraction layer.

In this implementation, the first embedded device: generates (or records) a first set of execution characteristics responsive to execution of the first container image at the first device; and transmits the first set of execution characteristics to the remote computer system. The remote computer system receives (or accesses) the first set of execution characteristics in Block S150.

For example, the first device can generate the first set of execution characteristics including: a first timeseries of processor utilizations; a second timeseries of memory utilizations; a third timeseries of network interface traffic; a completion time(s) corresponding to execution of the first container image; a file size of the first container image in storage (or memory) of the first device; etc.

The system can repeat the foregoing methods and techniques for each device, in the subset of target devices, corresponding to the first configuration: to execute the first container image within a container runtime environment—installed on the device—via a hardware abstraction layer; to generate a set of execution characteristics responsive to execution of the first container image at the device; and to transmit the set of execution characteristics to the remote computer system.

In response to receiving sets of execution characteristics from the subset of target devices, the remote computer system: generates a visualization depicting these sets of execution characteristics; and serves the visualization to the user via the user interface.

In another implementation, in Block S126, the remote computer system identifies a second set of operations characterized by the first instruction set architecture and corresponding to the initial set of operations based on the first set of attributes and the first set of execution characteristics.

In one example, the remote computer system: generates a prompt indicating the first set of attributes (e.g., the first instruction set architecture, the first processor type, the first application binary interface format), the initial set of operations (and/or the initial application binary), and/or the first set of execution metrics; serves the prompt to a model (e.g., a large language model); and identifies the second set of operations based on a response returned from the model according the prompt.

In this example, the remote computer system can generate the prompt indicating sets of execution characteristics responsive to execution of the first container image at devices, in the subset of target devices, corresponding to the first configuration.

In another example, the remote computer system receives the first set of execution characteristics indicating a first memory utilization associated with a second subset of operations (e.g., corresponding to a first tuning permutation and a first subset of operations represented in the initial container image) exceeding a threshold memory utilization.

In this example, in response to detection of the first memory utilization exceeding the threshold memory utilization, the remote computer system identifies a second set of operations including a third subset of operations—corresponding to the first subset of operations—based on the first set of attributes and the first set of execution metrics.

More specifically, the remote computer system can identify the third subset of operations based on a second expected memory utilization—associated with the third subset of operations—falling below the first memory utilization and falling below the threshold memory utilization.

In this variation, the remote computer system executes the foregoing methods and techniques: to translate the initial application binary into a second application binary representing the second set of operations in Block S130; to generate a second container image including the second application binary in Block S134; to store the second container image in the container image repository in Block S140; and to deploy the second container image onto the first device for execution in Block S146.

Therefore, the remote computer system can iteratively refine (or tune) operations included in an application binary specific to a device and/or an instruction set architecture of the device in order to increase performance of the application binary executed at the device and/or to achieve performance requirements defined by policy.

### 11. Vulnerability Scanning and Remediation

In one implementation, the remote computer system identifies a first set of components (e.g., libraries, functions, tools) included in (or associated with) a first container image stored in the container image repository; generates a first manifest specifying the first set of components; and stores the first manifest in the container image repository (or in another data repository) and associated with the first container image.

The remote computer system repeats the foregoing methods and techniques for each container image in the container image repository: to identify a set of components included in the container image; to generate a manifest specifying the set of components; and to store the manifest in the container image repository and associated with the container image.

In another implementation, as shown in FIG. 4, the remote computer system detects a vulnerability affecting a first component (e.g., a first library) in the first set of components in the first manifest and included in the first container image.

In response to detection of the vulnerability affecting the first component in the first set of components, the remote computer system: identifies a group of devices (e.g., the first device) onto which the first container image is deployed in Block S160; generates a notification indicating the vulnerability—affecting the first component associated with the first container image—and identifiers of the group of devices onto which the first container image is deployed in Block S162; serves the notification to the user in Block S164; and/or blocks deployment of the first container image to a device in the set of devices.

Additionally or alternatively, in response to detection of the vulnerability affecting the first component in the first set of components, the remote computer system can, based on the first set of attributes, identify a second set of operations: corresponding to the initial set of operations; characterized by the first instruction set architecture; and absent association with the first component in Block S126. The remote computer system can then execute the foregoing methods and techniques: to translate the initial application binary into a second application binary representing the second set of operations in Block S130; to generate a second container image including the second application binary in Block S134; to store the second container image in the container image repository in Block S140; and to deploy the second container image onto the first device for execution in Block S146.

For example, the remote computer system can: identify a second component (e.g., a second library) corresponding to the first component and absent vulnerabilities; and generate the second container image based on the first container image by replacing the first component with the second component.

Therefore, the remote computer system can proactively and automatically: scan the container image repository for vulnerabilities; block deployment of container images exhibiting vulnerabilities; update container images to remediate these vulnerabilities; and/or redeploy updated container images to devices.

### 12. Disclaimers

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
based on a request to deploy an initial container image onto a set of target devices, accessing the initial container image comprising an initial application binary:
representing an initial set of operations of an application, the initial set of operations comprising a first subset of operations characterized by a first quantity of operations; and
characterized by an initial instruction set architecture;
accessing a first set of attributes of a first device in the set of target devices, the first set of attributes characterized by:
a first instruction set architecture different from the initial instruction set architecture; and
a first processor type;
based on the first set of attributes, identifying a first set of operations corresponding to the initial set of operations and characterized by the first instruction set architecture, the first set of operations comprising a second subset of operations:
corresponding to the first subset of operations; and
characterized by a second quantity of operations falling below the first quantity of operations;
translating the initial application binary into a first application binary representing the first set of operations;
generating a first container image comprising the first application binary;
storing the first container image in a container image repository and in association with a first configuration characterized by:
the first instruction set architecture; and
the first processor type; and
deploying the first container image onto the first device for execution.

2. The method of claim 1, further comprising:
accessing a second set of attributes of a second device in the set of target devices;
in response to detection of a difference between the second set of attributes and the first configuration, identifying a second set of operations corresponding to the initial set of operations based on the second set of attributes;
translating the initial application binary into a second application binary representing the second set of operations;
generating a second container image comprising the second application binary;
storing the second container image in the container image repository and in association with a second configuration characterized by a subset of attributes in the second set of attributes; and
deploying the second container image onto the second device for execution.

3. The method of claim 2:
wherein accessing the second set of attributes comprises accessing the second set of attributes characterized by:
the first instruction set architecture; and
a second processor type different from the first processor type;
wherein identifying the second set of operations comprises identifying the second set of operations corresponding to the initial set of operations and characterized by the second instruction set architecture; and
wherein storing the second container image comprises storing the second container image in the container image repository and in association with the second configuration characterized by the second instruction set architecture.

4. The method of claim 2:
wherein accessing the second set of attributes comprises accessing the second set of attributes characterized by a second instruction set architecture different from:
the initial instruction set architecture; and
the first instruction set architecture;
wherein identifying the second set of operations comprises identifying the second set of operations corresponding to the initial set of operations and characterized by the second instruction set architecture; and
wherein storing the second container image comprises storing the second container image in the container image repository and in association with the second configuration characterized by:
the first instruction set architecture; and
the second processor type.

5. The method of claim 1, further comprising:
accessing a second set of attributes of a second device in the set of target devices;
in response to detection of correspondence between the second set of attributes and the first configuration, retrieving the first container image from the container image repository; and
deploying the first container image onto the second device for execution.

6. The method of claim 1:
further comprising, during a first time period:
accessing the application binary from an interface;
generating the initial container image comprising the application binary;
storing the initial container image in the container image repository;
generating a first set of tags representing the first set of attributes; and
installing the first set of tags on the first device;
wherein accessing the initial container image comprises, in response to reception of the request during a second time period succeeding the first time period, accessing the initial container image in the container image repository;
wherein accessing the first set of attributes comprises receiving an indication of the first set of tags from the first device during the second time period; and
wherein identifying the first set of operations comprises, based on the first set of tags, identifying the first set of operations corresponding to the initial set of operations and characterized by the first instruction set architecture.

7. The method of claim 6, further comprising:
during the first time period:
generating a second set of tags representing a second set of attributes of a second device on the set of target devices; and
installing the second set of tags on the second device; and
during the second time period:
receiving an indication of the second set of tags from the second device;
in response to detection of correspondence between the second set of tags and the first configuration, retrieving the first container image from the container image repository; and
deploying the first container image onto the second device for execution.

8. The method of claim 6:
wherein accessing the initial container image comprises:
receiving the request specifying a target set of tags; and
accessing the initial container image in response to validation of the target set of tags; and
wherein identifying the first set of operations comprises, based on the first set of tags, identifying the first set of operations corresponding to the initial set of operations and characterized by the first instruction set architecture in response to correspondence between the first set of tags and the target set of tags.

9. The method of claim 6:
wherein storing the initial container image comprises storing the initial container image characterized by an initial identifier; and
wherein storing the first container image comprises storing the first container image characterized by a first identifier:
mapped to the initial identifier as a first index element; and
associated with the first configuration.

10. The method of claim 1:
wherein accessing the initial container image comprises accessing the initial container image comprising the initial application binary representing a set of scalar load instructions and scalar multiply instructions;
wherein accessing the first set of attributes comprises accessing the first set of attributes characterized by the first instruction set architecture defining a set of vector instructions;
wherein identifying the first set of operations comprises, in response to detection of vector acceleration capability based on the set of vector instructions, identifying the second subset of operations comprising a set of vector operations:
corresponding to the first subset of operations comprising the set of scalar load operations and scalar multiplication operations; and
characterized by the second quantity of operations falling below the first quantity of operations; and
wherein translating the initial application binary into the first application binary comprises translating the initial application binary into the first application binary by replacing scalar load instructions and scalar multiply instructions with vector instructions in the set of vector instructions.

11. The method of claim 1, wherein identifying the first set of operations comprises:
identifying the second subset of operations, in a group of subsets of operations, corresponding to the first subset of operations;
calculating a first quantity of bits representing the second subset of operations;
calculating a first score, in a set of scores for the group of subsets of operations, for the second subset of operations based on the first quantity of bits; and
selecting the second subset of operations for the first set of operations in response to detection of the first score characterized by a greatest score in the set of scores.

12. The method of claim 1, further comprising:
accessing a set of execution characteristics responsive to execution of the first container image at the first device;
identifying a second set of operations corresponding to the initial set of operations and characterized by the first instruction set architecture based on:
the first set of attributes; and
the set of execution characteristics;
translating the initial application binary into a second application binary representing the second set of operations;
generating a second container image comprising the second application binary; and
deploying the second container image onto the first device for execution.

13. The method of claim 1:
wherein storing the first container image comprises generating a first manifest specifying a first set of components associated with the first container image;
further comprising, in response to detection of a vulnerability affecting a first component in the first set of components, identifying a group of devices onto which the first container image is deployed, the group of devices comprising the first device;
generating a notification indicating:
the vulnerability affecting the first component associated with the first container image; and
identifiers of the group of devices onto which the first container image is deployed; and
serving the notification to a user.

14. The method of claim 1:
wherein storing the first container image comprises generating a first manifest specifying a first set of components associated with the first container image;
further comprising, in response to detection of a vulnerability affecting a first component in the first set of components and based on the first set of attributes, identifying a second set of operations:
corresponding to the initial set of operations;
characterized by the first instruction set architecture; and
absent association with the first component;
translating the initial application binary into a second application binary representing the second set of operations;
generating a second container image comprising the second application binary; and
deploying the second container image onto the first device for execution.

15. The method of claim 1:
wherein accessing the initial container image comprises accessing the initial container image in response to reception of the request to deploy the initial container image onto the set of target devices comprising a set of embedded devices;
wherein accessing the first set of attributes comprises accessing the first set of attributes of the first device comprising a first embedded device in the set of embedded devices, the first set of attributes characterized by a first embedded application binary interface;
wherein translating the initial application binary into the first application binary comprises translating the initial application binary into the first application binary representing the first set of operations based on the first embedded application binary interface; and
wherein deploying the first container image onto the first device comprises deploying the first container image onto the first embedded device for execution.

16. A method comprising:
during a first time period:
accessing an initial application binary:
representing an initial set of operations of an application, the initial set of operations comprising a first subset of operations characterized by a first quantity of operations; and
characterized by an initial instruction set architecture;
generating an initial container image comprising the application binary;
storing the initial container image in a container image repository;
generating a first set of tags representing a first set of attributes of a first embedded device, the first set of tags specifying:
a first instruction set architecture different from the initial instruction set architecture; and
a first processor type;
installing the first set of tags on the first embedded device; and
during a second time period succeeding the first time period:
in response to reception of a request to deploy the initial container image onto a set of target embedded devices comprising the first embedded device, accessing the initial container image in the container image repository;
receiving an indication of the first set of tags from the first embedded device;
based on the first set of tags, identifying a first set of operations corresponding to the initial set of operations and characterized by the first instruction set architecture, the first set of operations comprising a second subset of operations:
corresponding to the first subset of operations; and
characterized by a second quantity of operations falling below the first quantity of operations;
translating the initial application binary into a first application binary representing the first set of operations;
generating a first container image comprising the first application binary;
storing the first container image in the container image repository and in association with a first configuration characterized by:
the first instruction set architecture; and
the first processor type; and
deploying the first container image onto the first embedded device for execution.

17. The method of claim 16, further comprising:
during the first time period:
generating a second set of tags representing a second set of attributes of a second embedded device in the set of target embedded devices, the second set of tags specifying:
the first instruction set architecture; and
a second processor type different from the first processor type; and
installing the second set of tags on the second embedded device; and
during the second time period:
receiving an indication of the second set of tags from the second embedded device;
in response to detection of a difference between the second set of tags and the first configuration, identifying a second set of operations corresponding to the initial set of operations and characterized by the first instruction set architecture, the first set of operations comprising a second subset of operations:
corresponding to the first subset of operations; and
characterized by a third quantity of operations corresponding to the first quantity of operations;
translating the initial application binary into a second application binary representing the second set of operations;
generating a second container image comprising the second application binary;
storing the second container image in the container image repository and in association with a second configuration characterized by:
the first instruction set architecture; and
the second processor type; and
deploying the second container image onto the second embedded device for execution.

18. The method of claim 16, further comprising:
during the first time period:
generating a second set of tags representing a second set of attributes of a second embedded device in the set of target embedded devices, the second set of tags specifying:
the first instruction set architecture; and
a second processor type different from the first processor type; and
installing the second set of tags on the second embedded device; and
during the second time period:
receiving an indication of the second set of tags from the second embedded device;
in response to detection of correspondence between the second set of tags and the first configuration, retrieving the first container image from the container image repository; and
deploying the first container image onto the second embedded device for execution.

19. A method comprising:
based on a request to deploy an initial container image onto a set of target devices, accessing the initial container image comprising an initial application binary:
representing an initial set of operations of an application; and
characterized by an initial instruction set architecture;
accessing a first set of attributes of a first device in the set of target devices, the first set of attributes characterized by:
a first instruction set architecture different from the initial instruction set architecture; and
a first processor type;
accessing a second set of attributes of a second device in the set of target devices, the second set of attributes characterized by:
the first instruction set architecture; and
a second processor type different from the first processor type;
based on the first set of attributes, identifying a first set of operations corresponding to the initial set of operations and characterized by the first instruction set architecture;
based on the second set of attributes, identifying a second set of operations:
different from the first set of operations;
corresponding to the initial set of operations; and
characterized by the first instruction set architecture;
translating the initial application binary into a first application binary representing the first set of operations;
translating the initial application binary into a second application binary representing the second set of operations;
generating a first container image comprising the first application binary;
generating a second container image comprising the second application binary;
storing the first container image in a container image repository and in association with a first configuration characterized by:
the first instruction set architecture; and
the first processor type;
storing the second container image in the container image repository and in association with a second configuration characterized by:
the first instruction set architecture; and
the second processor type;
deploying the first container image onto the first device for execution; and
deploying the second container image onto the second device for execution.

20. The method of claim 19:
wherein accessing the initial container image comprises accessing the initial container image comprising the initial application binary representing the initial set of operations comprising a first subset of operations characterized by a first quantity of operations;
wherein identifying the first set of operations comprises, based on the first processor type, identifying the first set of operations comprising a second subset of operations:
corresponding to the first subset of operations; and
characterized by a second quantity of operations falling below the first quantity of operations; and
wherein identifying the second set of operations comprises, based on the second processor type, identifying the second set of operations comprising a third subset of operations:
corresponding to the first subset of operations; and
characterized by a third quantity of operations corresponding to the first quantity of operations.
